(19) United States
(12) Patent Application Publication
(10) Pub. No.: US 2025/0329899 A1
(43) Pub. Date: Oct. 23, 2025

(54) POWER STORAGE MODULE

(71) Applicant: TOYOTA JIDOSHA KABUSHIKI KAISHA, Toyota-shi (JP)

(72) Inventors: Yusuke Ikeda, Miyoshi-shi (JP); Tetsuya Mimura, Chiryu-shi (JP); Tomofumi Hirukawa, Miyoshi-shi (JP); Hajime Hasegawa, Aichi-gun (JP); Shizuka Masuoka, Nagoya-shi (JP); Hiroki Awano, Susono-shi (JP); Kosuke Yonekawa, Nisshin-shi (JP); Jun Izumi, Toyota-shi (JP)

(73) Assignee: TOYOTA JIDOSHA KABUSHIKI KAISHA, Toyota-shi (JP)

(21) Appl. No.: 19/060,344

(22) Filed: Feb. 21, 2025

(30) Foreign Application Priority Data
Apr. 18, 2024 (JP) 2024-067541

(51) Int. Cl. H01M 50/586; H01M 50/103; H01M 50/548; H01M 50/636

(52) U.S. Cl. CPC H01M 50/586; H01M 50/103; H01M 50/548; H01M 50/636

(57) ABSTRACT

A power storage module includes a stacked electrode assembly including a plurality of electrodes stacked in a first direction. The stacked electrode assembly has a circumferential surface extending in a second direction perpendicular to the first direction, and facing a housing. The power storage module includes an insulating sheet portion disposed between the circumferential surface and the housing and covers the circumferential surface. The insulating sheet portion has first and second insulating sheets extending in the second direction and covering a portion of the circumferential surface. The first and second insulating sheets partially overlap in a circumferential direction of the stacked electrode assembly. The second direction is the longitudinal direction of the overlapped region where the first insulating sheet and the second insulating sheet overlap. The first and second insulating sheets are welded together at multiple locations separate from each other in the second direction in the overlapped region.

### CROSS REFERENCE TO RELATED APPLICATIONS

This nonprovisional application is based on Japanese Patent Application No. 2024-067541 filed on Apr. 18, 2024 with the Japan Patent Office, the entire content of which is hereby incorporated by reference.

### BACKGROUND

### Field

The present disclosure relates to a power storage module.

### Description of the Background Art

Conventionally, a power storage module including a stacked electrode assembly is known. As such a power storage module, Japanese Patent Laying-Open No. 2022-79186 discloses a prismatic secondary battery. The prismatic secondary battery includes: an outer package that includes an opening and a side wall which defines the opening; a hole sealing plate that seals the opening; an electrode assembly (a stacked electrode assembly) housed in the outer package; a current interruption mechanism provided between the hole sealing plate and the electrode assembly; and an insulation sheet arranged between the outer package and the electrode assembly and provided with a portion folded inwardly on a surface of the electrode assembly, the surface facing the current interruption mechanism.

Specifically, in the prismatic secondary battery, the electrode assembly is accommodated in the outer package constituting a battery case, while being wrapped with the insulation sheet shaped in one box or sack. The hole sealing plate has an electrolyte solution injection hole through which an electrolyte solution is injected into the battery case.

### SUMMARY

In the power storage module as disclosed in Japanese Patent Laying-Open No. 2022-79186, the insulation sheet is provided between the stacked electrode assembly and the housing (the battery case) accommodating the stacked electrode assembly, which may make the electrolyte solution injected through the injection hole difficult to impregnate into the stacked electrode assembly.

The present disclosure provides a power storage module which has enhanced impregnation property of the electrolyte solution injected through the injection hole into the stacked electrode assembly, while assuring the insulation between the stacked electrode assembly and the housing accommodating the stacked electrode assembly.

According to a certain aspect of the present disclosure, the power storage module includes: a stacked electrode assembly impregnated with an electrolyte solution; and a housing accommodating the stacked electrode assembly. The stacked electrode assembly includes a plurality of electrodes stacked in a first direction and extending in a second direction perpendicular to the first direction. The stacked electrode assembly has a circumferential surface extending in the second direction and facing the housing. The power storage module further includes an insulating sheet portion disposed between the circumferential surface and the housing and covers the circumferential surface. The insulating sheet portion has a first insulating sheet and a second insulating sheet which extend in the second direction and cover a portion of the circumferential surface. The first insulating sheet and the second insulating sheet partially overlap in a circumferential direction of the stacked electrode assembly. The second direction is a longitudinal direction of an overlapped region where the first insulating sheet and the second insulating sheet overlap. The first insulating sheet and the second insulating sheet are welded together at a plurality of locations apart from each other in the second direction in the overlapped region.

With the above configuration, the injected electrolyte solution can be supplied to the stacked electrode assembly through the gaps between the first insulating sheet and the second insulating sheet at unwelded portions of the overlapped regions of the first insulating sheet and the second insulating sheet. Thus, according to the power storage module, the electrolyte solution injected in the power storage module from outside the power storage module into the stacked electrode assembly have enhanced impregnation property, while the insulation between the housing and the stacked electrode assembly is ensured.

Preferably, two overlapped regions are located apart from each other in the circumferential direction. In each of the overlapped regions, the first insulating sheet and the second insulating sheet are welded together at a plurality of locations in the second direction.

With the above configuration, the impregnation property of the electrolyte solution into the stacked electrode assembly can be enhanced, as compared to only one of the two overlapped regions is welded entirely across the second direction.

Preferably, the housing has an end surface on the second direction side. An injection hole through which the electrolyte solution is injected into the power storage module is formed in the end surface. The circumferential surface has first and second primary surfaces on the first direction side and first and second side surfaces on a third direction side perpendicular to the first and second directions. The first and second side surfaces continue to the first and second primary surfaces, respectively. One of the two overlapped regions covers at least a portion of the first side surface in the first direction and the other one of the two overlapped regions covers at least a portion of the second side surface in the first direction.

With the above configuration, since multiple electrodes are stacked in the first direction in the stacked electrode assembly, as the electrolyte solution is gravity flown into the stacked electrode assembly in the second direction via the injection hole, the electrolyte solution flows with ease toward the first and second side surfaces than toward the first and second primary surfaces. In particular, since the overlapped regions has created a bump, the electrolyte solution is likely to flow toward the first and second side surfaces. Furthermore, the overlapped regions have portions where the first insulating sheet and the second insulating sheet are not welded together. Thus, according to the power storage module, the impregnation property of the electrolyte solution into the stacked electrode assembly can be enhanced.

Preferably, a length of the housing and a length of the electrode in a third direction perpendicular to the first direction and the second direction are longer than a length of the housing and a length of the electrode in the first direction. A length of the housing and a length of the electrode in the second direction are longer than a length of the housing and a length of the electrode in the third direction. The housing has an end surface on the second direction side. An external connection terminal is formed on the end surface. The terminal is electrically connected to the stacked electrode assembly.

With the above configuration, the length in the second direction is the longest of the lengths of the power storage module in the first direction, the second direction, and the third direction. In general, the power storage module having such a shape tends to have poor liquid injection property in the second direction, which is the longitudinal direction of the power storage module. However, according to the power storage module, the electrolyte solution can be supplied to the stacked electrode assembly through the gap between the first insulating sheet and the second insulating sheet as noted above. Therefore, the liquid injection property in the second direction can be ensured. Thus, according to the power storage module, the impregnation property of the injected electrolyte solution into the stacked electrode assembly can be enhanced.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a power storage module.

FIG. 2 is a diagram showing a stacked electrode assembly included in the power storage module of FIG. 1.

FIG. 3 is a cross-sectional arrow view of the power storage module, taken along a III-III line of FIG. 1.

FIG. 4 is an isolated view of the stacked electrode assembly and an insulating sheet portion of FIG. 3.

FIG. 5 is a diagram showing the insulating sheet portion of FIG. 4 as viewed in an orientation indicated by an arrow V.

### DESCRIPTION OF THE PREFERRED EMBODIMENTS

Hereinafter, an embodiment according to the present disclosure will be described, with reference to the accompanying drawings. Note that the embodiment below uses the same reference signs to refer to the same or common parts, and description thereof will not be repeated.

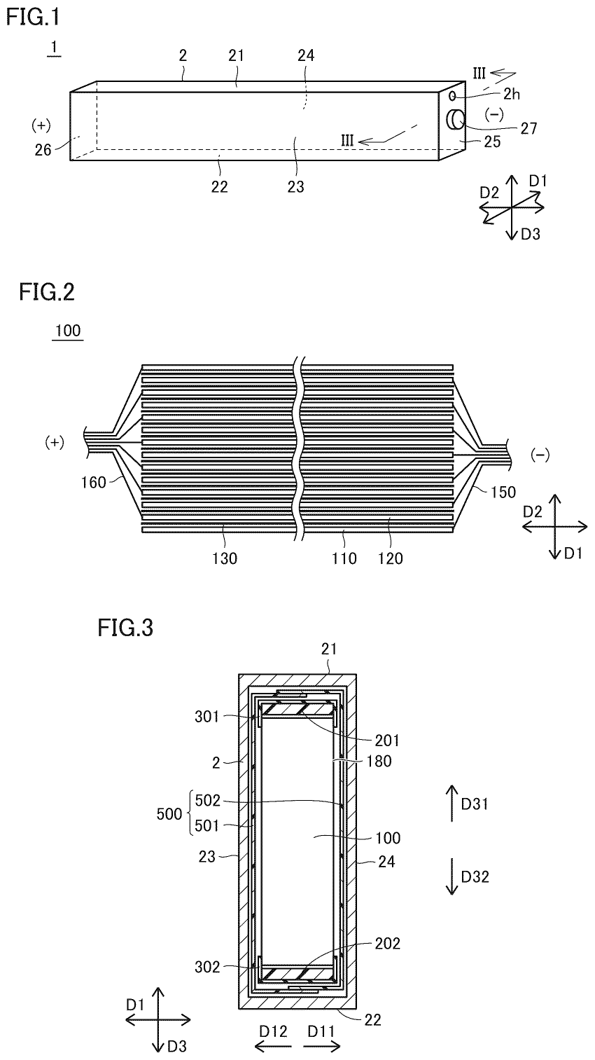

FIG. 1 is a perspective view of a power storage module according to the present embodiment. FIG. 2 is a diagram showing a stacked electrode assembly included in the power storage module of FIG. 1. As shown in FIGS. 1 and 2, a power storage module 1 has a blade shape. Power storage module 1 includes a stacked electrode assembly 100 and a housing 2 accommodating stacked electrode assembly 100. Note that, in the following, for convenience of illustration, power storage module 1 will be described, with reference to an example in which the power storage module 1 is oriented so that a D3 direction shown in FIGS. 1, 2, etc. is the vertical direction (more specifically, the orientation of D31 described below is vertically upward), except when an electrolyte solution is injected, which will be described below.

Power storage module 1 is, in this example, a lithium iron phosphate (LFP) battery. However, the present disclosure is not limited thereto. Power storage module 1 may be a nickel manganese cobalt (NMC) battery. Power storage module 1 is mounted on, for example, a battery electric vehicle traveling with a driving force obtained from electrical energy. Specifically, a battery pack, including multiple power storage modules 1 aligned in a predetermined direction, is mounted on a battery electric vehicle. The battery pack is mounted on the vehicle body of the battery electric vehicle. The battery pack constitutes a part of the vehicle body. The battery pack serves as the structure of the vehicle body.

As shown in FIG. 1, housing 2 has a generally cuboid shape. Housing 2, in this example, is made of metal. Housing 2 has first to sixth surfaces 21 to 26. A first surface 21, a second surface 22, a third surface 23, and a fourth surface 24 continue in the listed order. First surface 21, second surface 22, third surface 23, and fourth surface 24 constitute the outer circumferential surface of housing 2.

A fifth surface 25 and a sixth surface 26 are end surfaces of housing 2. First surface 21 is the top surface, second surface 22 is the bottom surface, and third surface 23 and fourth surface 24 are side surfaces. A negative-side external connection terminal 27 is disposed on fifth surface 25. A positive-side external connection terminal (not shown) is disposed on sixth surface 26.

D1 direction is the width direction of power storage module 1. As shown in FIG. 2, stacked electrode assembly 100 includes multiple electrodes stacked in D1 direction (a laminate direction). Specifically, in stacked electrode assembly 100, a negative electrode 110 and a positive electrode 120 are stacked in D1 direction with a separator 130 in-between. Stacked electrode assembly 100 further includes tabs 150 connected to negative-side external connection terminal 27 and tabs 160 connected to the positive-side external connection terminal. As such, stacked electrode assembly 100 is electrically connected to negative-side external connection terminal 27 and the positive-side external connection terminal. Tab 150 is a collection of copper foils. Tab 160 is a collection of aluminum foils.

As shown in 1, power storage module 1 and housing 2 extend in D2 direction. As shown in FIG. 2, stacked electrode assembly 100 extends in D2 direction. D2 direction is perpendicular to D1 direction. D2 direction is the longitudinal directions of power storage module 1, housing 2, and stacked electrode assembly 100. D3 direction is perpendicular to D1 direction and D2 direction. D3 direction is the height direction of power storage module 1.

D1 direction is the lateral directions of first surface 21, second surface 22, fifth surface 25, and sixth surface 26. D2 direction is the longitudinal directions of first to fourth surfaces 21 to 24. D3 direction is the lateral directions of third and fourth surfaces 23 and 24 and the longitudinal directions of fifth and sixth surfaces 25 and 26.

An injection hole 2h is formed in fifth surface 25 for injecting an electrolyte solution into housing 2. Injection hole 2h is formed closer to first surface 21 of housing 2 than second surface 22. Injection hole 2h is formed closer to first surface 21 than external connection terminal 27. Note that in FIG. 1, since the electrolyte solution is already injected inside the housing 2, injection hole 2h is sealed. Injection hole 2h may be temporarily sealed by inserting a detachable stopper into injection hole 2h. Alternatively, injection hole 2h may be sealed with a resin or a metal so that no electrolyte solution can be injected into housing 2 again, unless the through-hole is opened.

When the electrolyte solution is injected into housing 2 through injection hole 2h, for example, during the manufacturing of power storage module 1, the orientation of power storage module 1 is kept so that D2 direction is substantially the vertical direction and fifth surface 25 is located above the sixth surface 26. Due to the self-weight of the electrolyte solution, the electrolyte solution flows from the fifth surface 25 side to the sixth surface 26 side. Note that the electrolyte solution, since it has a certain degree of viscosity, falls within housing 2 at a slow speed. This allow the electrolyte solution to be impregnated into stacked electrode assembly 100.

In this example, injection hole 2h is formed closer to first surface 21 than external connection terminal 27. However, the present disclosure is not limited thereto. Injection hole 2h may be formed closer to second surface 22 than external connection terminal 27. Injection hole 2h may be formed closer to third surface 23 than external connection terminal 27. Injection hole 2h may be formed closer to fourth surface 24 than external connection terminal 27.

Further in this example, injection hole 2h is formed in fifth surface 25. However, the present disclosure is not limited thereto. For example, injection hole 2h may be formed in sixth surface 26. Injection hole 2h may be formed in first surface 21 or second surface 22. When injection hole 2h is formed in first surface 21 or second surface 22, preferably, injection hole 2h is formed closer to the end side (the fifth surface 25 side or the sixth surface 26 side) of housing 2 in the longitudinal direction than the middle portion from the standpoint of liquid injection property. Injection hole 2h may be formed in third surface 23 or fourth surface 24. The location of formation of injection hole 2h is not particularly limited.

As noted above, power storage module 1 has the blade shape. Thus, housing 2 has a blade shape too. Stacked electrode assembly 100 accommodated in housing 2 has a blade shape too. Thus, the lengths of housing 2, negative electrode 110, and positive electrode 120 in D3 direction are longer than the lengths of housing 2, negative electrode 110, and positive electrode 120 in D1 direction. Furthermore, the lengths of housing 2, negative electrode 110, and positive electrode 120 in D2 direction are longer than the lengths of the housing, negative electrode 110, and positive electrode 120 in D3 direction.

The length of housing 2 in D3 direction is, by way of example, six or seven times the length of housing 2 in D1 direction. The length of housing 2 in D2 direction is, by way of example, ten to eleven times the length of housing 2 in D3 direction. However, the ratio between the length of housing 2 in D1 direction and the length of housing 2 in D2 direction and the length of housing 2 in D3 direction is not limited thereto.

FIG. 3 is a cross-sectional arrow view of power storage module 1, taken along a III-III line of FIG. 1. As shown in 3, power storage module 1 further includes plate-like members 201 and 202, tape materials 301 and 302, and an insulating sheet portion 500. Insulating sheet portion 500 includes a first insulating sheet 501 and a second insulating sheet 502.

Plate-like members 201 and 202, tape materials 301 and 302, and insulating sheet portion 500 are accommodated in housing 2, as with stacked electrode assembly 100. Plate-like members 201 and 202, tape materials 301 and 302, and insulating sheet portion 500 are disposed (in a gap) between stacked electrode assembly 100 and housing 2.

Plate-like members 201 and 202 extend in D2 direction. Plate-like members 201 and 202 are disposed within housing 2 so that the thickness direction of the plate-like member 201 is D3 direction. In this example, plate-like member 202 and plate-like member 201 have shapes that are symmetrical about stacked electrode assembly 100. However, the present disclosure is not limited thereto.

Multiple through-holes, extending in D3 direction, are formed in plate-like members 201 and 202. The through-holes that are alighted in D2 direction are formed in plate-like members 201 and 202. Note that the power storage module 1 may not necessarily include plate-like members 201 and 202.

Plate-like members 201 and 202 are insulators. In this example, plate-like members 201 and 202 are each formed of a resin. Plate-like members 201 and 202 are, in this example, each formed of an insulative material from the standpoint of prevention of a short circuit between positive electrode 120 and negative electrode 110 of stacked electrode assembly 100. Note that if an insulating distance is sufficiently secured between stacked electrode assembly 100 and plate-like members 201 and 202, plate-like members 201 and 202 may not necessarily be insulators.

For example, polypropylene is used as a material constituting plate-like members 201 and 202. However, the present disclosure is not limited thereto. For example, polyethylene, polyphenylene sulfide, poly ether ether ketone, or polyethylene terephthalate (PET) may be used.

Plate-like member 201 is disposed above the stacked electrode assembly 100. Specifically, plate-like member 201 is disposed directly above the stacked electrode assembly 100. Plate-like member 201 is placed on the first surface 21 side of housing 2. Plate-like member 201 is placed in the orientation of D31 of D3 direction, relative to stacked electrode assembly 100. Note that the orientation of D31 is vertically upward, as noted above.

Plate-like member 202 is disposed below the stacked electrode assembly 100. Specifically, plate-like member 202 is disposed directly below the stacked electrode assembly 100. Plate-like member 202 is placed on the second surface 22 side of housing 2. Plate-like member 202 is placed in the orientation of D32 of D3 direction, relative to stacked electrode assembly 100. Note that the orientation of D32 is vertically downward.

Plate-like member 201 is secured to stacked electrode assembly 100 by a tape material 301. Tape material 301 extends in D2 direction. Tape material 301 covers all or part of first surface 211 of plate-like member 201. Tape material 301 covers all or part of third and fourth surfaces 213 and 214 of plate-like member 201. Tape material 301 covers part of stacked electrode assembly 100.

Plate-like member 202 is secured to stacked electrode assembly 100 by a tape material 302. Tape material 302 extends in D2 direction. Tape material 302 covers all or part of first surface 221 of plate-like member 202. Tape material 302 covers all or part of third and fourth surfaces 223 and 224 of plate-like member 202. Tape material 302 covers part of stacked electrode assembly 100.

Stacked electrode assembly 100 has a circumferential surface 180. Circumferential surface 180 extends in D2 direction. FIG. 3 shows a lateral cross-section of circumferential surface 180. The lateral cross-section of circumferential surface 180 has a rectangular shape. Surfaces constituting circumferential surface 180 will be described below.

Insulating sheet portion 500 is disposed between circumferential surface 180 of stacked electrode assembly 100 and housing 2 and covers circumferential surface 180. Insulating sheet portion 500 insulates stacked electrode assembly 100 and housing 2 from each other. Insulating sheet portion 500 covers stacked electrode assembly 100 to prevent stacked electrode assembly 100 from touching housing 2. Insulating sheet portion 500 is provided between stacked electrode assembly 100 and housing 2 (specifically, the inner surface of the housing) to prevent a short circuit of stacked electrode assembly 100.

Specifically, first insulating sheet 501 partially covers plate-like members 201 and 202. First insulating sheet 501 covers plate-like member 201 via tape material 301. Similarly, first insulating sheet 501 covers plate-like member 202 via tape material 302.

Specifically, second insulating sheet 502 partially covers plate-like members 201 and 202. Second insulating sheet 502 covers plate-like member 201 via tape material 301. Similarly, second insulating sheet 502 covers plate-like member 202 via tape material 302.

An end portion of first insulating sheet 501 and an end portion of second insulating sheet 502 are welded together. First and second insulating sheets 501 and 502 are wrapped around tape materials 301 and 302, plate-like members 201 and 202, and stacked electrode assembly 100, while plate-like members 201 and 202 are secured to stacked electrode assembly 100 by tape materials 301 and 302. Subsequently, the end portion of first insulating sheet 501 and the end portion of second insulating sheet 502 are welded together, and insulating sheet portion 500 of FIG. 3 results.

Note that, for example, polypropylene is used as a material constituting first and second insulating sheets 501 and 502. However, the present disclosure is not limited thereto. For example, polyethylene, polyphenylene sulfide, poly ether ether ketone, nylon, or polyethylene terephthalate (PET) may be used.

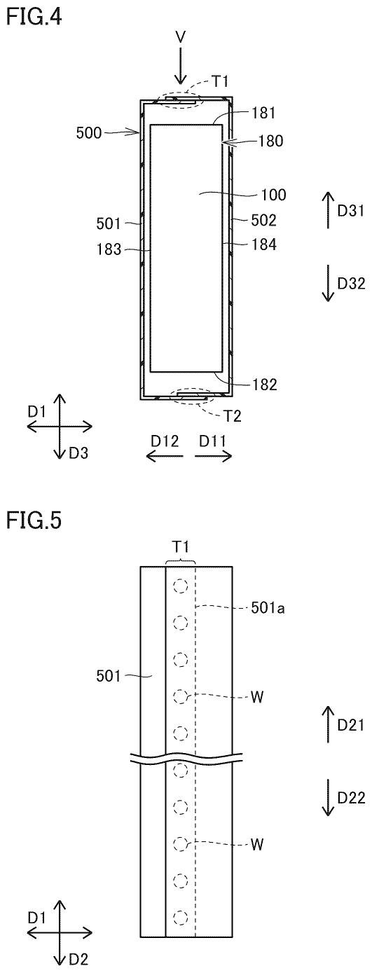

FIG. 4 is an isolated view of stacked electrode assembly 100 and insulating sheet portion 500 of FIG. 3. As shown in FIG. 4, circumferential surface 180 of stacked electrode assembly 100 has first and second side surfaces 181 and 182 on the D3 direction side and first and second primary surfaces 183 and 184 on the D1 direction side. In other words, circumferential surface 180 has first and second side surfaces 181 and 182 whose normal directions are D3 direction and first and second primary surfaces 183 and 184 whose normal directions are D1 direction.

First side surface 181 continues to first and second primary surfaces 183 and 184. First side surface 181 is the top surface. Similarly, second side surface 182 continues to first and second primary surfaces 183 and 184. Second side surface 182 is the bottom surface.

As shown in FIGS. 3 and 4, first side surface 181 is in parallel to first surface 21 of housing 2. Second side surface 182 is in parallel to second surface 22. First side surface 181 is closer to first surface 21 of housing 2 than second side surface 182 is. First primary surface 183 is in parallel to third surface 23. Second primary surface 184 is in parallel to fourth surface 24. First primary surface 183 is closer to third surface 23 than second primary surface 184 is. The widths (lengths) of first and second side surfaces 181 and 182 in D1 direction are narrower than the widths (lengths) of first and second primary surfaces 183 and 184 in D3 direction.

First insulating sheet 501 and second insulating sheet 502 partially overlap in the circumferential direction of stacked electrode assembly 100. The longitudinal directions of overlapped regions T1 and T2, where first insulating sheet 501 and second insulating sheet 502 overlap, are D2 direction. Overlapped regions T1 and T2 extend in D2 direction. As such, the two overlapped regions T1 and T2 are located apart from each other in the circumferential direction of stacked electrode assembly 100.

Note that the “circumferential direction” is the direction of circumferential surface 180. In this example, the “circumferential direction,” in FIG. 4, is the direction starting from first side surface 181 to second primary surface 184, second side surface 182, and first primary surface 183 (the clockwise direction in FIG. 4), for example.

In overlapped region T1, the D31-side end portion of first insulating sheet 501 and the D31-side end portion of second insulating sheet 502 overlap and are welded together. In overlapped region T2, the D32-side end portion of first insulating sheet 501 and the D32-side end portion of second insulating sheet 502 overlap and are welded together.

In this example, overlapped region T1 covers first side surface 181. Overlapped region T2 covers second side surface 182. Overlapped region T1 covers a portion of first side surface 181 in D1 direction. Overlapped region T2 covers a portion of second side surface 182 in D1 direction. However, the present disclosure is not limited thereto. Overlapped region T1 may fully cover first side surface 181 in D1 direction. Overlapped region T2 may fully cover second side surface 182 in D1 direction. However, from the standpoint of the impregnation property of the electrolyte solution into the stacked electrode assembly, preferably, overlapped regions T1 and T2 cover a portion of first side surface 181 and a portion of second side surface 182, respectively.

Note that, in overlapped region T1, second insulating sheet 502 is on the D31 side than first insulating sheet 501 is. In overlapped region T2, second insulating sheet 502 is on the D31 side than first insulating sheet 501 is. However, which one of first insulating sheet 501 and second insulating sheet 502 is superimposed on top of the other is not limited thereto.

FIG. 5 is a diagram showing insulating sheet portion 500 of FIG. 4 as viewed in an orientation indicated by an arrow V. FIG. 5 is a top view of insulating sheet portion 500 of FIG. 4.

As shown in FIG. 5, first insulating sheet 501 and second insulating sheet 502 are welded together at multiple locations W apart from each other in D2 direction in overlapped region T1. Similarly, first insulating sheet 501 and second insulating sheet 502 are welded together at multiple locations W apart from each other in D2 direction in overlapped region T2 (not shown in FIG. 5). Each location W is heat welded by a hot iron or the like. Each location W is a welded location.

In this example, portions W are equidistantly apart from each other in D2 direction. However, the present disclosure is not limited thereto. The spacing between adjacent portions W may not be constant. For example, the closer to the middle portion of insulating sheet portion 500 in D2 direction, the longer the separation distance between portions W may be.

### Summary

(1) As described above, power storage module 1 includes stacked electrode assembly 100 impregnated with the electrolyte solution and housing 2 accommodating stacked electrode assembly 100. Stacked electrode assembly 100 includes multiple electrodes (the negative electrode 110 and the positive electrode 120) that are stacked in D1 direction and extend in D2 direction perpendicular to D1 direction. Stacked electrode assembly 100 has circumferential surface 180 extending in D2 direction and facing the housing 2.

Power storage module 1 further includes insulating sheet portion 500 disposed between circumferential surface 180 and housing 2 and covering circumferential surface 180. Insulating sheet portion 500 has first insulating sheet 501 and second insulating sheet 502 that extend in D2 direction and cover a portion of circumferential surface 180.

First insulating sheet 501 and second insulating sheet 502 partially overlap in the circumferential direction of stacked electrode assembly 100. The longitudinal direction of overlapped regions T1 and T2, where first insulating sheet 501 and second insulating sheet 502 overlap, is D2 direction. First insulating sheet 501 and second insulating sheet 502 are welded together at multiple locations W apart from each other in D2 direction in overlapped regions T1 and T2.

With such a configuration, the injected electrolyte solution can be supplied to stacked electrode assembly 100 through the gaps between first insulating sheet 501 and the second insulating sheet at unwelded portions of overlapped regions T1 and T2 of first insulating sheet 501 and second insulating sheet 502. Thus, according to power storage module 1, the electrolyte solution injected in power storage module 1 from outside the power storage module 1 into stacked electrode assembly 100 have enhanced impregnation property, while the insulation between housing 2 and stacked electrode assembly 100 is ensured.

(2) The two overlapped regions T1 and T2 are located apart from each other in the circumferential direction. In each of overlapped regions T1 and T2, first insulating sheet 501 and second insulating sheet 502 are welded together at multiple locations W apart from each other in D2 direction.

With such a configuration, the impregnation property of the electrolyte solution into stacked electrode assembly 100 can be enhanced, as compared to only one of the two overlapped regions T1 and T2 is welded entirely across D2 direction.

(3) Housing 2 has fifth surface 25 in D2 direction. Injection hole 2h, through which the electrolyte solution is injected into power storage module 1, is formed in the fifth surface 25. Circumferential surface 180 has first and second primary surfaces 183 and 184 in D1 direction and first and second side surfaces 181 and 182 in D3 direction. First and second side surfaces 181 and 182 continue to first and second primary surfaces 183 and 184, respectively. One of the two overlapped regions T1 and T2 (in this example, overlapped region T1) covers at least a portion of first side surface 181 in the first direction, and the other one of the two overlapped regions T1 and T2 (overlapped region T2) covers at least a portion of second side surface 182 in the first direction.

With such a configuration, since multiple electrodes are stacked in D1 direction in stacked electrode assembly 100, as the electrolyte solution is gravity flown into stacked electrode assembly 100 in D2 direction via injection hole 2h, the electrolyte solution flows with ease toward first and second side surfaces 181 and 182 than toward first and second primary surfaces 183 and 184. In particular, since overlapped regions T1 and T2 has created a bump, the electrolyte solution is likely to flow toward first and second side surfaces 181 and 182. Furthermore, overlapped regions T1 and T2 have portions where first insulating sheet 501 and second insulating sheet 502 are not welded together. Thus, according to power storage module 1, the impregnation property of the electrolyte solution into stacked electrode assembly 100 can be enhanced.

(4) The lengths of housing 2 and the electrodes (negative electrode 110 and positive electrode 120) in D3 direction are longer than the lengths of housing 2 and the electrodes in D1 direction. The lengths of housing 2 and the electrodes in D2 direction are longer than the lengths of housing 2 and the electrodes in D3 direction. As shown in FIG. 1, housing 2 has fifth surface 25 on the D2 direction side. External connection terminal 27 is formed on fifth surface 25. External connection terminal 27 is electrically connected to stacked electrode assembly 100.

With such a configuration, the length in D2 direction is the longest of the lengths of power storage module 1 in D1 direction, D2 direction, and D3 direction. In general, the power storage module having such a shape tends to have poor liquid injection property in D2 direction, which is the longitudinal direction of power storage module 1. However, according to power storage module 1, the electrolyte solution can be supplied to stacked electrode assembly 100 through the gap between first insulating sheet 501 and second insulating sheet 502 as noted above. Therefore, the liquid injection property in D2 direction can be ensured. Thus, according to power storage module 1, the impregnation property of the injected electrolyte solution into stacked electrode assembly 100 can be enhanced even if the length of power storage module 1 in D2 direction is the longest of the lengths of power storage module 1 in D1 direction, D2 direction, and D3 direction.

While the embodiments according to the present disclosure has been described above, the presently disclosed embodiments should be considered in all aspects illustrative and not restrictive. The scope of the present disclosure is defined by the appended claims. All changes which come within the meaning and range of equivalency of the appended claims are to be embraced within their scope.

What is claimed is:

1. A power storage module, comprising:
a stacked electrode assembly impregnated with an electrolyte solution; and
a housing accommodating the stacked electrode assembly, wherein
the stacked electrode assembly includes a plurality of electrodes stacked in a first direction and extending in a second direction perpendicular to the first direction,
the stacked electrode assembly has a circumferential surface extending in the second direction and facing the housing,
the power storage module further includes an insulating sheet portion disposed between the circumferential surface and the housing and covers the circumferential surface, wherein
the insulating sheet portion has a first insulating sheet and a second insulating sheet which extend in the second direction and cover a portion of the circumferential surface,
the first insulating sheet and the second insulating sheet partially overlap in a circumferential direction of the stacked electrode assembly, and the second direction is a longitudinal direction of an overlapped region where the first insulating sheet and the second insulating sheet overlap, and
the first insulating sheet and the second insulating sheet are welded together at a plurality of locations apart from each other in the second direction in the overlapped region.

2. The power storage module according to claim 1, wherein
two overlapped regions are located apart from each other in the circumferential direction, and
in each of the overlapped regions, the first insulating sheet and the second insulating sheet are welded together at a plurality of locations in the second direction.

3. The power storage module according to claim 2, wherein
the housing has an end surface on the second direction side,
an injection hole through which the electrolyte solution is injected into the power storage module is formed in the end surface,
the circumferential surface has first and second primary surfaces on the first direction side and first and second side surfaces on a third direction side perpendicular to the first and second directions,
the first and second side surfaces continue to the first and second primary surfaces, respectively, and
one of the two overlapped regions covers at least a portion of the first side surface in the first direction and the other one of the two overlapped regions covers at least a portion of the second side surface in the first direction.

4. The power storage module according to claim 1, wherein
a length of the housing and a length of the electrode in a third direction perpendicular to the first direction and the second direction are longer than a length of the housing and a length of the electrode in the first direction,
a length of the housing and a length of the electrode in the second direction are longer than a length of the housing and a length of the electrode in the third direction,
the housing has an end surface on the second direction side,
an external connection terminal is formed on the end surface, and
the external connection terminal is electrically connected to the stacked electrode assembly.
